(19) United States
(12) Patent Application Publication
(10) Pub. No.: US 2026/0350730 A1
(43) Pub. Date: Nov. 5, 2026

(54) SYSTEMS AND METHOD FOR REAL-TIME WILL CREATING, END OF LIFE MANAGEMENT, AUTHENTICATION, AND TRANSMISSION

(71) Applicant: Charles Chibuike Ibe, Lekki (NG)

(72) Inventor: Charles Chibuike Ibe, Lekki (NG)

(21) Appl. No.: 19/197,586

(22) Filed: May 2, 2025

(51) Int. Cl. G06Q 50/18; G06F 21/32; G06F 21/60

(52) U.S. Cl. CPC G06Q 50/186; G06F 21/32; G06F 21/602

(57) ABSTRACT

A digital will management system and method are provided for creating, storing, authenticating, and transmitting a user's last will and testament using a mobile application. The system offers a jurisdiction-specific, legally compliant will template assisted by artificial intelligence to guide the user through inputting beneficiary, asset, and executor information. The completed will and associated sensitive data are encrypted and securely stored. Biometric recognition, including facial and fingerprint authentication, monitors user activity to manage an inactivity timer. Upon detecting a predefined period of inactivity, the system automatically transmits the encrypted will to designated beneficiaries, executors, or probate authorities. The platform further enables digital authentication by witnesses and legal counsel, supports secure updating of documents, and ensures data integrity through advanced encryption and secure server architecture, addressing longstanding challenges in will creation, maintenance, and execution.

### CROSS-REFERENCE TO RELATED APPLICATIONS

The present application claims priority to U.S. Provisional Patent Application No. 63/764,837 filed Feb. 28, 2025, titled “SYSTEMS AND METHODS FOR DIGITAL WILL MANAGEMENT WITH BIOMETRIC INACTIVITY DETECTIONS”, which is hereby incorporated by reference in its entirety.

### TECHNICAL FIELD

The embodiments disclosed herein generally relate to legal documentation and estate management. More particularly, it relates to a software application designed to create, manage, authenticate, and securely store and transmit a last testament or will, utilizing mobile biometric technologies and secure server-based time-dependent release mechanisms.

### BACKGROUND

The practice of will creation dates back centuries, serving as a fundamental means for individuals to dictate the distribution of their assets and the care of dependents after death. Traditionally, wills have been prepared manually, often with the assistance of legal professionals to ensure compliance with the prevailing laws and formalities of the jurisdiction. The process has historically involved the drafting of handwritten or typed documents, witnessed by disinterested parties, and securely stored in physical locations such as law offices or safes.

Despite the critical importance of wills, the traditional approach to creating and managing these documents has been fraught with challenges. The manual nature of the process often results in high costs, both in terms of legal fees and time investments. Individuals are typically required to visit legal practitioners multiple times to update their wills, leading to delays and sometimes discouraging regular updates that reflect life changes such as marriages, divorces, births, or deaths. Furthermore, physical wills are vulnerable to loss, destruction, or unauthorized alterations, posing significant risks to the integrity and enforceability of the testator's intentions.

Technological advancements have gradually introduced digital tools for document drafting and storage, but the adoption of these technologies in the realm of will creation has been limited. Many available digital solutions lack compliance with jurisdiction-specific legal requirements, provide insufficient security measures for sensitive information, or fail to address critical end-of-life triggers for document activation and distribution. As a result, individuals remain hesitant to rely solely on digital platforms for such significant legal instruments.

Moreover, emotional barriers, procrastination, and perceived complexities surrounding the will-making process have left a substantial portion of the adult population without any testamentary planning. Studies have indicated that a majority of adults, particularly younger demographics, do not have a will, often citing a lack of urgency, uncertainty about the process, or concerns over legal costs. These deficiencies in the traditional and current systems highlight a clear market need for an accessible, secure, legally compliant, and user-friendly digital solution.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a system and method for creating, storing, managing, authenticating, and transmitting a user's last will and testament. The invention addresses longstanding inefficiencies and vulnerabilities associated with traditional will preparation, which relies heavily on manual processes, legal expertise, and physical document handling. Through the use of modern mobile technologies, biometric authentication, artificial intelligence (AI), and secure automated transmission protocols, the invention offers a transformative solution for estate planning.

The system provides a mobile application designed with a jurisdiction-specific, legally compliant will-writing template. This template is dynamically configured based on the user's country of residence and relevant probate requirements, ensuring that documents are immediately enforceable without costly or complex legal intervention. The application simplifies the user experience while preserving strict adherence to the legal standards necessary for testamentary documents.

The system utilizes AI-assisted guidance during will creation. The application employs algorithms to analyze user input regarding assets, beneficiaries, debts, guardians, and executors, suggesting appropriate legal structures and language for the will. This adaptive approach removes much of the guesswork for users unfamiliar with legal terminology and reduces errors that could otherwise invalidate the document.

The system further integrates biometric authentication to manage user activity and security. It employs facial recognition, fingerprint scanning, and optionally behavioral analytics to verify that the intended user remains engaged with the system. Biometric authentication ensures that access to the will and sensitive estate information is limited to the rightful owner, reducing the risks of impersonation or unauthorized access.

The system provides an inactivity-based automated transmission system. After the user sets a specific inactivity threshold, ranging between 12 to 60 months, the application continuously monitors for biometric indications of the user's activity. If the threshold period elapses without detection of user presence, the system automatically transmits the encrypted will to predesignated beneficiaries, executors, probate offices, or trusted legal entities.

Secure storage of the will and related documents forms a critical component of the system. The platform uses encryption standards such as AES-256 for data at rest and TLS for data in transit, protecting the integrity and confidentiality of highly sensitive user data. This dual encryption approach provides resilience against data breaches, tampering, or unauthorized disclosures.

A transmission engine securely manages the dispatch of documents when conditions for automatic delivery are satisfied. Users can specify transmission through secure email links, blockchain-based transfer mechanisms, or direct server-to-server communication. This ensures that beneficiaries and executors receive the necessary documents in a timely, authenticated manner without requiring intervention by a third party.

In some embodiments, the integration of a digital authentication feature for witnesses and legal participants is included. Witnesses, executors, and legal counsel can authenticate their roles through secure digital signatures and biometric verification, ensuring that the will's execution process meets both legal standards and modern cybersecurity protocols. This feature dramatically reduces the potential for posthumous disputes over document validity.

The system enables users to update and revise their will in real time, offering flexibility that traditional paper-based wills cannot match. Changes made through the application are revalidated against applicable legal standards and re-encrypted to maintain continuous compliance and security. This dynamic update capability ensures that a user's final wishes are always current, even as their life circumstances evolve.

Access control within the application is enforced through role-based access control (RBAC) frameworks combined with multi-factor authentication (MFA). Each role, whether beneficiary, executor, or legal representative, is assigned specific permissions that are strictly enforced to prevent unauthorized data access. This hierarchical approach to security strengthens trust and minimizes insider threats.

To further enhance security, the system incorporates behavioral analytics monitoring. Typing patterns, device interaction habits, and geolocation data are analyzed to establish a behavioral baseline for each user. Deviations from this established pattern can trigger security alerts, initiate additional authentication checks, or temporarily lock sensitive functions until user identity can be reconfirmed.

The server security architecture is designed to exceed legal and regulatory compliance standards, including GDPR, HIPAA, and PCI-DSS. Regular security audits, vulnerability scanning, and dependency management are integral to the architecture, ensuring that system defenses remain current against emerging cybersecurity threats. This ongoing diligence maintains a high standard of data protection for all users.

A reputation scoring system can be optionally implemented for executors, witnesses, and other participants. This module enables users to review ratings and endorsements from previous interactions, providing an added layer of trust in selecting responsible parties. It enhances accountability and helps users make informed decisions regarding who participates in the execution of their estate plan.

Privacy control features empower users to designate granular permissions over their data. Users can define who may view, edit, or receive specific sections of the will, offering unparalleled flexibility and personalization. This ensures that sensitive information, such as financial details or custody instructions, is only shared with appropriate parties.

The mobile time machine feature enables the use of real-time biometric monitoring to manage inactivity thresholds. Unlike systems that rely solely on device disuse as a proxy for inactivity, the invention cross-validates biometric and behavioral data to more accurately determine user presence. This approach minimizes the risk of erroneous will transmission while ensuring that timely action is taken when necessary.

The system's encryption model supports modular, hierarchical access to sensitive data components. Certain information, such as bank account credentials or cryptocurrency wallets, can be encrypted under separate keys with restricted access. This layered protection enables differentiated levels of document exposure depending on user preferences and recipient roles.

An audit trail and chain-of-custody module records all interactions with the stored will and associated documents. Every access event, update, authentication, or transmission is logged immutably, creating a verifiable history that can be referenced in case of legal disputes. This transparent record-keeping system greatly enhances document credibility and enforceability.

The embodiments incorporate a disaster recovery plan as part of its server infrastructure. Regular encrypted backups, geographic redundancy, and rapid recovery protocols ensure that even in the event of catastrophic failure, user data remains protected and accessible. This resilience guarantees continuity in fulfilling user testamentary wishes under all circumstances.

A secure API framework is provided to allow authorized third-party systems, such as probate courts or legal services providers, to interact with the system. Access through the API is governed by strict authentication and authorization protocols, preserving the system's overall security posture while enhancing interoperability with external stakeholders.

The application supports cross-platform compatibility, ensuring users can manage their wills from smartphones, tablets, or desktop web interfaces. This multi-device support improves accessibility and encourages regular engagement with the user's estate planning process. It ensures that users are not constrained by technology when managing critical life documents.

Periodic security awareness campaigns and in-app training modules are integrated into the user experience. These educational efforts are designed to enhance user knowledge regarding phishing risks, data hygiene, and authentication practices. Informed users form a critical line of defense against social engineering attacks and unauthorized access attempts.

The system utilizes blockchain technology to timestamp will versions immutably. Every update to a user's will can be hashed and recorded on a decentralized ledger, providing irrefutable proof of the document's existence and content at a specific point in time. This innovation further reduces disputes and strengthens the evidentiary value of stored documents.

In summary, the platform revolutionizes the way individuals create, manage, and execute their wills. By combining user-centric design, legal compliance, biometric security, real-time updating, secure storage, and automated transmission, the invention offers a comprehensive and modern solution to a historically cumbersome process. It empowers users to maintain control over their final wishes in a way that is secure, efficient, and trustworthy.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates a block diagram of the application program in communication with the computing system, according to some embodiments; and

FIG. 3 illustrates a flowchart of a method for creating, storing, and transmitting a will and testament, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a digital platform designed to facilitate the secure creation, management, authentication, and transmission of a last will and testament using a mobile device. The system offers a highly secure, user-friendly environment that ensures legal compliance, minimizes traditional barriers to will preparation, and automates execution procedures based on user-defined conditions. By leveraging biometric monitoring, artificial intelligence (AI), encryption technologies, and automated communications, the invention provides a comprehensive testamentary management solution that meets both user needs and legal standards.

As used herein, the term “will” refers to a legal document, also known as a last will and testament, through which a user directs the distribution of their property, assets, and responsibilities upon death. The will may also designate guardians for minor children and appoint executors to administer the estate. In the context of the present invention, the will is created, stored, authenticated, and transmitted electronically through the application program.

The term “asset inventories” or “assets” refers to the collection of tangible and intangible properties owned by a user, including but not limited to real estate, bank accounts, investment holdings, business interests, intellectual property, and digital assets such as cryptocurrency. Asset inventories are entered into the application program during the will drafting process and are used to specify how property should be distributed to designated beneficiaries. The asset data is securely stored and may be updated dynamically throughout the user's lifetime.

The term “beneficiaries” refers to individuals, organizations, or legal entities designated by the user to receive specific assets or entitlements under the terms of the will. Beneficiaries may include family members, friends, charitable organizations, or any party identified by the testator. In the context of the present invention, beneficiary information is collected during the drafting process and securely stored and linked to corresponding asset allocations.

The term “executors” refers to individuals appointed by the user to manage and administer the estate according to the instructions provided in the will. Executors are responsible for ensuring that the user's assets are distributed properly, debts are settled, and legal requirements are fulfilled during the probate process. Within the application program, executor designations may be digitally authenticated and verified to ensure their authority at the time of execution.

The term “guardians” refers to persons appointed within the will to assume responsibility for the care and custody of minor children or dependents in the event of the user's death. Guardians are identified during the will drafting process and may also be authenticated within the system to confirm their acceptance of the role. The guardian designations are securely stored and associated with specific instructions provided by the user in the will document.

The system is composed of several interconnected functional modules, each responsible for specific operations within the system. These modules include a User Interface (UI) Module, a Will Drafting and Compliance Engine, a Secure Storage Module, a Biometric Monitoring Engine, an Inactivity Detection and Transmission Module, an Authentication and Digital Signature Module, and an Access Control and Privacy Settings Module. The harmonious interaction among these components enables seamless functionality, maximizes security, and ensures compliance with regional legal frameworks.

The User Interface (UI) Module serves as the primary point of interaction between the user and the system. The UI is designed to be intuitive and user-friendly, offering clear prompts and responsive design to guide the user through the steps necessary to create a comprehensive and legally compliant will. It supports mobile and desktop environments, allowing users to access the system conveniently from smartphones, tablets, or computers.

The Will Drafting and Compliance Engine underpins the legal robustness of the system. This engine dynamically generates will templates based on the user's jurisdiction by analyzing applicable probate laws and mandatory clauses. The AI capabilities of the engine further assist users by suggesting default options, flagging potential inconsistencies, and ensuring that all statutory requirements for a valid will are met, minimizing the need for external legal counsel.

The Secure Storage Module ensures that user-generated wills and sensitive associated documents are safely preserved. All data within this module is encrypted using the AES-256 standard for data at rest and secured with TLS protocols during transmission. The module also implements redundancy and real-time backup systems, safeguarding user documents against accidental deletion, hardware failure, or cybersecurity breaches.

The Biometric Monitoring Engine continuously authenticates user presence and identity during system interaction and inactivity periods. It uses multiple biometric factors, including facial recognition, fingerprint scanning, and optional behavioral analysis, to verify that only the authorized user can access or update the will. This engine serves as a foundational security measure, preventing impersonation or fraudulent access to testamentary documents.

Embedded within the Biometric Monitoring Engine is the Behavioral Analytics Subsystem, which creates a behavioral profile of each user. This subsystem monitors typing cadence, touch interaction patterns, and device usage behaviors, creating a unique user signature. Anomalies detected relative to the behavioral baseline trigger alerts or additional authentication challenges, enhancing security without compromising user convenience.

The Inactivity Detection and Transmission Module oversees the secure dispatch of a user's will based on defined periods of inactivity. Users can set an inactivity window, typically between 12 and 60 months, during which biometric or behavioral activity must be detected to prevent automatic execution. If no activity is detected within the preset timeframe, the system initiates secure transmission of the user's encrypted will to predetermined beneficiaries, executors, or probate institutions.

Transmission under the Inactivity Detection and Transmission Module occurs via secure and authenticated channels. Options include encrypted email delivery, blockchain ledger updates, or secure server-based distribution links that require multifactor authentication by the recipient. This redundancy ensures that the user's final wishes are reliably delivered under a wide range of operational circumstances.

The Authentication and Digital Signature Module enables witnesses, executors, and other parties to authenticate their involvement with the will. Participants provide biometric verification or digital certificates to sign the will electronically, satisfying jurisdictional witnessing requirements. This feature enhances the enforceability of the document while reducing dependency on traditional in-person notarization.

The Access Control and Privacy Settings Module grants users fine-grained control over the visibility of will contents. Through this module, users define who can view, edit, or receive specific parts of their estate plan, applying role-based access controls that are enforced consistently across the platform. Privacy management tools ensure that sensitive information, such as financial credentials, remains accessible only to trusted recipients.

The Encryption Management Subsystem coordinates encryption operations across different layers of user data. By applying modular encryption, users can encrypt specific components of their estate plan separately, enhancing control and minimizing exposure of particularly sensitive information like account numbers, passwords, and digital asset keys. The system also manages key rotation and secure key storage processes.

The Reputation Scoring Subsystem is an optional feature that allows users to evaluate potential witnesses, executors, and guardians. This system aggregates user feedback, completion rates, and prior authentication behaviors into a score, assisting users in selecting reliable, trustworthy collaborators for their estate planning. Reputation scores further deter malicious actors from participating within the platform.

The Secure API Framework enables controlled interactions between the system and trusted third-party services, such as courts, law firms, and banks. Each external access request is authenticated using token-based security and encrypted communication protocols, preserving the integrity and confidentiality of user data during integration operations.

The Audit Trail and Chain-of-Custody Subsystem records every action performed within the system, from document creation and editing to authentication events and transmission activities. All entries are timestamped and cryptographically secured to ensure that no historical records can be altered post hoc. This immutable audit trail supports dispute resolution by providing definitive proof of actions taken and parties involved.

The Disaster Recovery and Backup Subsystem maintains the resilience of the platform in the face of server outages, natural disasters, or cyberattacks. Encrypted backups are created on a regular schedule and distributed across multiple geographic locations with automatic failover capabilities. This infrastructure ensures continuity of service and preservation of critical testamentary data under adverse conditions.

Security Governance Framework protocols are embedded throughout the system to ensure compliance with data protection laws such as GDPR, HIPAA, and PCI-DSS. Organizational policies enforce rigorous data classification, user role verification, breach detection, and response measures. Regular external audits and vulnerability assessments help maintain the system's high security standards over time.

The system's multi-platform accessibility ensures that users can create, update, and manage their wills from multiple devices, including smartphones, tablets, and web browsers. A consistent and adaptive user experience is maintained across all device types, maximizing accessibility and supporting user engagement across diverse technological environments.

The Blockchain Timestamping Feature uniquely strengthens document authenticity by recording cryptographic hashes of user wills on a distributed ledger. Each time a will is created or modified, the updated document's fingerprint is immutably logged, providing incontrovertible evidence of the document's history. This measure substantially reduces the risk of tampering or forgery claims.

The Privacy Control Subsystem empowers users to manage exposure of different document elements through customizable permissions. Each document section can be independently assigned access rights based on the user's preferences, allowing granular control over visibility without sacrificing the integrity of the document as a whole. This flexibility supports both personal privacy and legal compliance requirements.

The User Education and Awareness Module enhances user security through proactive outreach and training materials embedded within the application. It provides periodic alerts about new cybersecurity threats, delivers phishing prevention tutorials, and offers reminders about best practices for maintaining secure accounts. A more informed user base helps strengthen the overall integrity of the system.

Session Management policies are implemented to protect against session hijacking and unauthorized persistence. User sessions automatically expire after defined periods of inactivity or upon detection of anomalous behavior, requiring reauthentication to regain access. Session tokens are securely managed and encrypted, ensuring continuity without compromising security.

The Notification Management System ensures timely and secure communication regarding user document statuses, authentication requests, inactivity warnings, and transmission alerts. Notifications are encrypted during delivery and configured to protect the sensitivity of the information contained within each message. This system keeps users and their designated recipients informed without jeopardizing privacy.

Financial Institution Integration APIs allow users to link their estate planning documents with live financial account data, including balances, investment portfolios, and digital assets. This integration ensures that wills reflect current asset holdings and allows for dynamic updating without user intervention. Financial data is accessed using secure, read-only channels and is subject to strict authentication policies.

Altogether, the platform represents a comprehensive and forward-looking solution for digital estate planning. By integrating modular security, dynamic compliance, biometric authentication, real-time behavioral monitoring, blockchain timestamping, and automated execution protocols, the system provides users with unparalleled control over their testamentary documents. The invention dramatically improves accessibility, efficiency, and reliability in the traditionally cumbersome process of will preparation and execution.

In certain embodiments, artificial intelligence (AI) may be employed within the application program to assist users in drafting, managing, and validating their wills. AI algorithms can analyze user input regarding assets, beneficiaries, executors, guardians, and specific legal wishes to dynamically generate customized will documents that comply with jurisdictional requirements. By leveraging AI assistance, the invention simplifies the traditionally complex process of will drafting, making it more accessible to users without formal legal training.

The AI system may further guide users through the will creation process by prompting them to consider commonly omitted categories of information, such as contingent beneficiaries, special bequests, or guardianship alternatives. Based on the user's demographics, family structure, and asset types, the AI engine can suggest default selections or recommend alternative approaches to asset distribution that align with local probate practices. These intelligent prompts reduce drafting errors and ensure more comprehensive and enforceable testamentary documents.

In some embodiments, AI may be utilized to analyze jurisdiction-specific legal data to dynamically adapt will templates in real-time. Upon identifying the user's location or country of residence, the AI engine can automatically include required legal clauses, formatting requirements, and witness protocols to ensure compliance. This localization reduces the risk that a user's will would later be deemed invalid due to minor procedural deviations from applicable legal standards.

The AI system may also monitor changes in applicable estate laws, probate regulations, and tax codes over time. When legislative updates occur that could impact the enforceability or tax consequences of a user's will, the AI engine can alert the user and recommend specific updates to the document. This dynamic monitoring ensures that stored wills remain aligned with the most current legal frameworks, even years after initial drafting.

AI algorithms may assist in verifying the internal consistency of the will by cross-referencing designated beneficiaries, executors, guardians, and asset inventories. For instance, if a user inadvertently allocates the same asset to multiple beneficiaries or appoints an executor who is also a minor, the AI engine can flag these inconsistencies for user review. This real-time validation improves document accuracy and reduces the likelihood of probate disputes.

In certain embodiments, AI may be integrated into the user module to enhance biometric authentication security. Behavioral AI models may track user-specific patterns such as typing rhythms, device interaction habits, and navigational flows to build individualized behavioral profiles. These profiles can be used alongside physiological biometrics to detect unauthorized access attempts or subtle changes in user behavior that could indicate fraud.

The AI system may further optimize inactivity detection algorithms within the activity monitoring module. Rather than relying solely on fixed inactivity timers, AI models can analyze historical user activity patterns, health metrics (where available), and biometric engagement data to predict and validate genuine cases of user incapacitation or death. This predictive approach improves the reliability of automated will transmission events while minimizing false triggers.

Additionally, AI may be employed to analyze beneficiary trustworthiness or executor reliability through machine learning models trained on reputation data. When users select beneficiaries or executors, the AI engine can provide optional insights into their historical behavior within the platform or flag anomalies based on peer-reviewed trust scores. Such features offer users enhanced decision-making tools when configuring their estate plans.

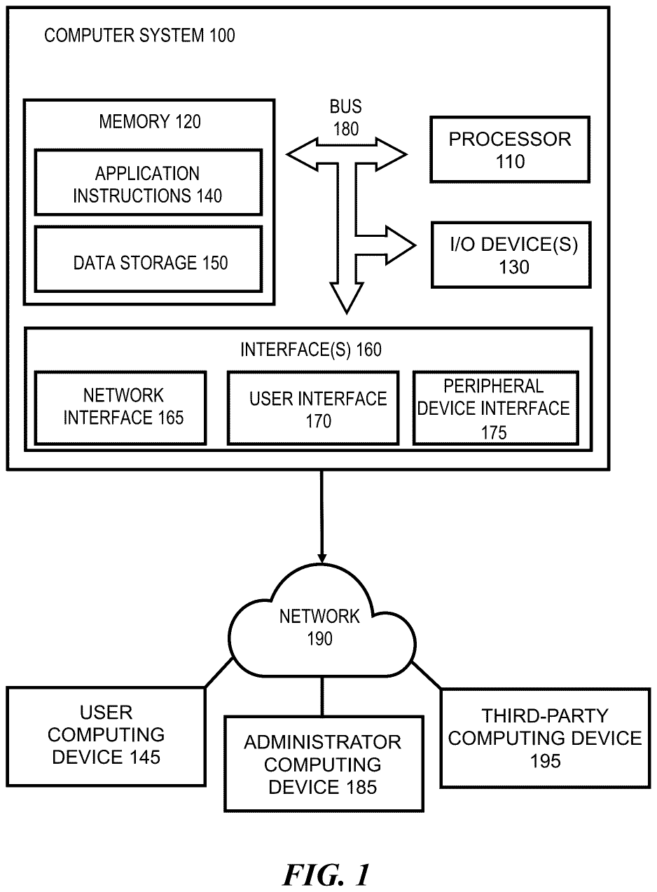

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

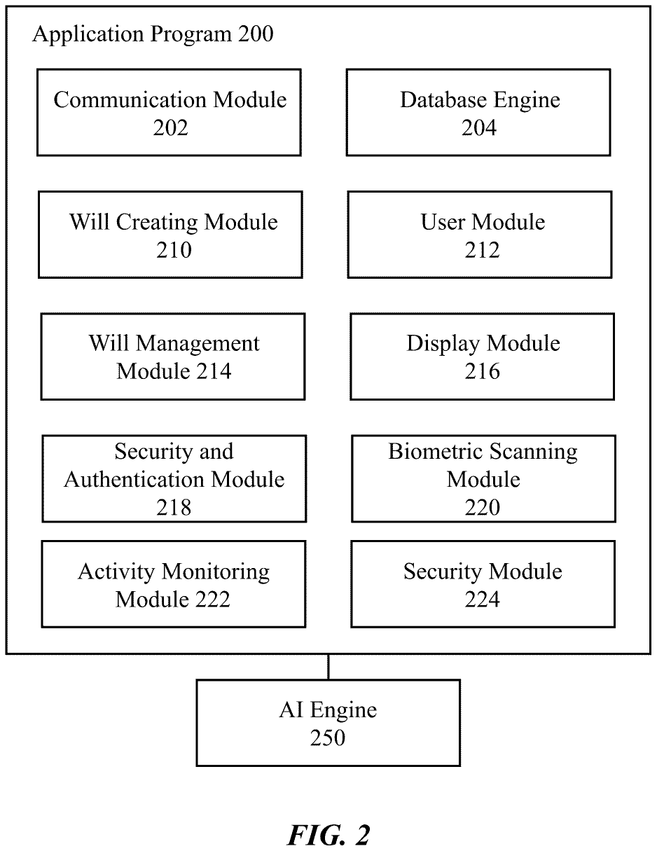

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a will creating module 210, a user module 212, a will management module 214, a display module 216, a security and authentication module 218, a biometric scanning module 220, an activity monitoring module 222, a security module 224, and AI engine 250.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 allows each user to transmit and receive information which may be used by the system.

The communication module 202 manages data exchanges between the computing system 100, external servers, third-party services, and authorized recipients. It establishes secure communication channels using industry-standard encryption protocols, such as TLS or VPN technologies, to protect data in transit. The communication module 202 may also implement endpoint verification and secure token handshakes to authenticate the identity of external systems or devices attempting to access user data.

In some embodiments, the communication module 202 handles internal message delivery within the platform itself. This includes sending alerts about pending authentication tasks, document update confirmations, or inactivity-triggered notifications to beneficiaries. The module may maintain audit trails of all outgoing and incoming communications for transparency and accountability.

The communication module 202 can be configured to manage secure transmission of the will upon fulfillment of inactivity conditions. It supports multiple delivery methods, including encrypted email, blockchain transmission, and secure web access, allowing users to select a preferred communication strategy during initial setup. Communication redundancy mechanisms ensure successful delivery even if a primary method fails.

In some embodiments, the communication module 202 may cooperate with the AI engine 250 to intelligently select the optimal method for transmitting the will or associated documents. Based on real-time network conditions, recipient authentication status, or detected threat levels, the AI engine 250 may dynamically determine whether encrypted email, blockchain transaction, or secure server access offers the most secure and efficient delivery path. The AI engine 250 may further monitor delivery success rates and adapt future transmission strategies accordingly.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. The database engine 204 allows each user and module associated with the system to transmit and receive information stored in various databases.

The database engine 204 oversees the secure storage and retrieval of all critical data associated with the application program 200. This includes user profile data, biometric templates, will documents, version histories, access logs, and transmission records. The database engine 204 is configured to encrypt all stored data at rest and implements strict access controls to prevent unauthorized modifications.

In some embodiments, the database engine 204 supports a distributed storage architecture with redundant backup nodes to enhance data durability and system resilience. Database replication techniques may be employed to maintain real-time copies of critical user data across geographically separated server clusters. This setup ensures disaster recovery readiness and minimizes potential data loss events.

The database engine 204 may include optimized indexing and search capabilities to facilitate efficient retrieval of user data when needed, such as during authentication or document updates. To ensure regulatory compliance, the database engine 204 may further support data retention policies, anonymization protocols, and user data deletion on request under applicable privacy regulations.

The database engine 204 may utilize the AI engine 250 to manage data optimization, redundancy, and predictive storage strategies. For example, the AI engine 250 can analyze access frequency, user update patterns, and document sensitivity levels to recommend backup intervals, data partitioning methods, or geographic storage assignments. In some embodiments, the AI engine 250 assists in maintaining regulatory compliance by automatically flagging stored records requiring archival or deletion under evolving data protection laws.

The will creating module 210 provides the core functionality for drafting a user's last will and testament within the application program 200. It supplies jurisdiction-specific templates that are automatically customized based on the user's location and selected preferences. The templates include standard clauses for asset distribution, guardianship, executor appointments, and special instructions, ensuring compliance with local probate requirements.

Artificial intelligence assistance may be integrated into the will creating module 210 to guide users through the drafting process. The AI can suggest default provisions, flag missing critical information, and offer recommendations based on user demographics, asset types, and familial structures. In some embodiments, the AI adapts the user interface in real-time to streamline document creation.

The will creating module 210 enables users to save drafts, revisit unfinished documents, and preview their wills before finalization. Upon completion, the module triggers the encryption and authentication workflows to preserve document integrity. In certain versions, the module may support multi-language drafting and customized templates for individuals with unique estate needs.

The will creating module 210 may leverage the AI engine 250 to dynamically generate jurisdiction-specific templates and provide intelligent drafting assistance. As the user inputs asset details, beneficiaries, and instructions, the AI engine 250 analyzes the entries in real-time to suggest applicable legal clauses, identify missing information, or highlight inconsistencies. In certain embodiments, the AI engine 250 accesses updated legal databases to recommend optimal asset distribution structures and minimize potential probate disputes.

The user module 212 manages individual user profiles, authentication credentials, biometric templates, and user-specific configuration settings. It maintains comprehensive profiles that associate each user with their biometric identifiers, contact information, encryption keys, privacy preferences, and activity thresholds for document transmission.

During onboarding, the user module 212 guides users through account creation, initial biometric enrollment, and setting up security parameters such as multi-factor authentication. The module may integrate with device-native security features, such as Touch ID or Face ID, to enhance onboarding convenience and authentication robustness.

The user module 212 also governs user-specific permissions regarding document editing, sharing, and revision authority. It maintains associations between users and designated roles (e.g., testator, witness, executor) to enforce access controls throughout the lifecycle of the will. The user module 212 plays a pivotal role in preserving data integrity and aligning the system's operation with individual user intents.

The user module 212 may cooperate with the AI engine 250 to personalize user authentication settings and privacy configurations. Based on observed user behavior, login patterns, and biometric enrollment characteristics, the AI engine 250 may suggest enhanced security measures or streamlined authentication flows. Additionally, the AI engine 250 may monitor user preferences over time and propose dynamic adjustments to privacy settings to better align with changing security needs or regulatory environments.

The will management module 214 oversees the complete lifecycle of each user's will from creation to final transmission or revocation. It coordinates version control, tracking changes made to the document over time, and ensuring that all amendments are properly timestamped and archived. This module helps prevent unauthorized overwrites or loss of historical document versions.

The will management module 214 also handles will updating workflows, allowing users to modify beneficiaries, executors, asset allocations, or legal instructions as circumstances change. The module automatically validates updates against jurisdictional requirements and triggers reauthentication when necessary to preserve document integrity.

Upon detecting user inactivity per predefined thresholds, the will management module 214 cooperates with the communication module 202 and security module 224 to initiate document transmission. It also records the successful dispatch of the will and maintains audit logs documenting transmission actions for legal verification purposes.

The will management module 214 may utilize the AI engine 250 to monitor changes in estate laws, tax regulations, and probate procedures that could impact existing wills. Upon detecting a relevant legal change, the AI engine 250 can prompt the user to update affected sections of their document and suggest appropriate amendments. In some embodiments, the AI engine 250 assists in automatically generating updated draft language for user review, minimizing the administrative burden of maintaining a current will.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

The display module 216 provides a dynamic and responsive interface for user interaction with the application program 200. It renders all graphical user interface (GUI) components necessary for will drafting, editing, reviewing, authentication approvals, and configuration management. The display module 216 adapts layouts based on the user's device type and screen size to ensure a consistent and accessible user experience.

In some embodiments, the display module 216 integrates contextual help overlays, visual guides, and validation highlights to assist users in completing required information. When drafting a will, the display module 216 may show side-by-side views of asset inventories, beneficiary lists, and distribution diagrams to simplify estate planning.

The display module 216 further supports real-time feedback from the AI assistance engine, dynamically presenting warnings or suggestions without interrupting user workflow. Through customized theming and accessibility features (such as larger fonts or text-to-speech support), the module ensures usability across a wide demographic of users.

In some embodiments, the display module 216 may be enhanced by the AI engine 250 to offer contextual assistance, dynamic tooltips, and predictive form completion. As the user navigates the application, the AI engine 250 can analyze the drafting flow and anticipate information needs, providing relevant visual aids or highlighting sections requiring additional attention. This intelligent guidance improves user confidence and reduces drafting time without overwhelming the user interface.

The security and authentication module 218 enforces systemwide security controls over user access, session management, authentication verification, and anomaly detection. It governs the authentication lifecycle, from initial login through secure session maintenance and eventual logout or timeout termination.

The security and authentication module 218 may incorporate the AI engine 250 to build behavioral user profiles for enhanced fraud detection. By continuously analyzing login locations, device usage patterns, biometric input timing, and session behaviors, the AI engine 250 can identify deviations from expected norms. When an anomaly is detected, the AI engine 250 may trigger additional verification requirements, alert system administrators, or temporarily restrict access pending further authentication.

Multi-factor authentication is coordinated by the security and authentication module 218, combining password entry with biometric verifications or OTP token validation. When behavioral anomalies are detected, such as unusual device access or geographic inconsistencies, the module may challenge users with additional verification steps or temporarily restrict access.

The module also monitors authentication logs, detects repeated failed access attempts, and triggers administrative alerts or automatic account lockdowns when suspicious behavior is detected. By continually evaluating user access patterns and session states, the security and authentication module 218 plays a central role in maintaining system integrity and protecting sensitive testamentary documents.

The biometric scanning module 220 captures, processes, and verifies physiological user characteristics for authentication and activity monitoring. It supports various biometric modalities, including facial recognition, fingerprint scans, voiceprint analysis, and behavioral biometrics depending on device capabilities and user settings.

During authentication attempts, the biometric scanning module 220 compares captured biometric data to enrolled templates stored securely in the database engine 204. Matching algorithms are used to assess biometric consistency with configured thresholds to minimize false acceptances or rejections.

Beyond login authentication, the biometric scanning module 220 may periodically validate user presence during active sessions and across configured inactivity periods. This continuous biometric validation enables proactive detection of device theft, unauthorized handoff, or impersonation, further enhancing platform security.

The biometric scanning module 220 may leverage the AI engine 250 to refine user verification processes by analyzing subtle biometric variations over time. For instance, facial recognition inputs may be cross-referenced with historical data to detect liveness, emotional stress, or aging effects. The AI engine 250 thus enhances both security and user experience by adapting biometric thresholds dynamically while reducing false rejection rates.

The activity monitoring module 222 tracks ongoing user interaction patterns to measure session engagement and detect inactivity periods. It monitors a range of activity signals, including biometric authentication events, application usage patterns, keyboard or touchscreen activity, and device movement.

When user activity falls below a predefined threshold for a configured period, the activity monitoring module 222 calculates the elapsed inactivity time. If the inactivity period surpasses the user-defined limit, the module triggers workflows for initiating will transmission or activating emergency notifications to authorized recipients.

The activity monitoring module 222 may also cooperate with the biometric scanning module 220 to validate whether inactivity is genuine or whether the device is still being used by an unauthorized person. This tight coupling ensures reliable inactivity detection while maintaining user privacy and operational transparency.

The activity monitoring module 222 may collaborate with the AI engine 250 to create predictive models for user inactivity detection. Rather than applying static timers alone, the AI engine 250 analyzes historical activity trends, device usage intervals, and biometric engagement data to anticipate likely inactivity events. This predictive monitoring enables more accurate and timely initiation of document transmission processes while minimizing unnecessary alerts.

The security module 224 implements encryption, blockchain timestamping, audit logging, and data integrity controls throughout the application program 200. It manages encryption key generation, secure storage, and lifecycle rotation to protect user data from creation to final transmission.

The security module 224 ensures that each will, and associated document is encrypted using strong algorithms before being stored or transmitted. It further manages modular encryption strategies where different sections of the will are encrypted separately, supporting differential access permissions among beneficiaries, witnesses, and executors.

Additionally, the security module 224 interacts with blockchain services to create immutable timestamp records for finalized documents. It coordinates secure audit logging of user activities and administrative events, providing forensic-grade transparency to support dispute resolution and compliance with legal standards.

The security module 224 may utilize the AI engine 250 to dynamically adjust encryption levels, key management strategies, and access permissions based on detected security threats or evolving user profiles. In some embodiments, the AI engine 250 monitors external cybersecurity advisories and automatically updates cryptographic protocols to counter emerging vulnerabilities. This proactive intelligence ensures that the application program 200 maintains best-in-class protection for sensitive user data and testamentary documents.

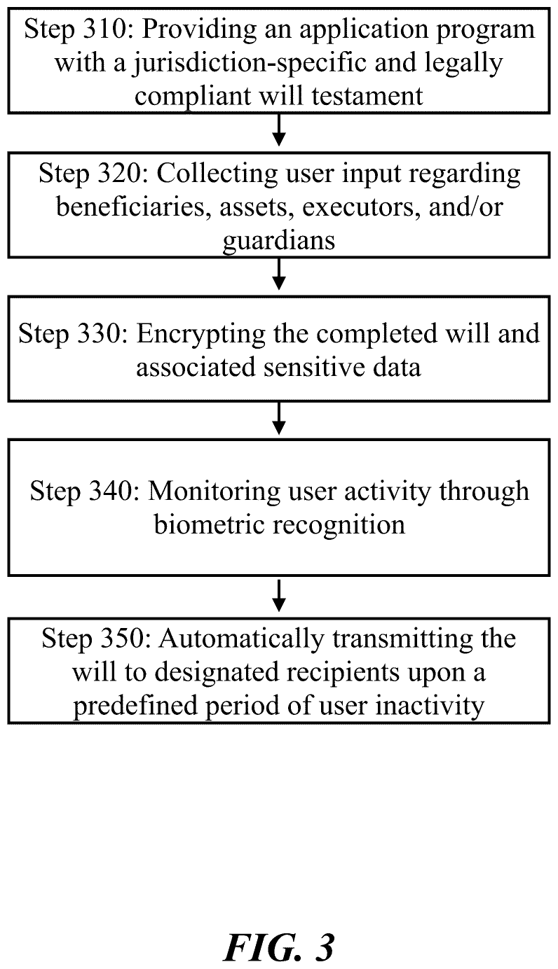

FIG. 3 illustrates a method for drafting, securing, monitoring, and transmitting a will and testament using the application program. At step 310, the user accesses the application program through the computing system to begin drafting a last will and testament. The user is presented with a jurisdiction-specific legal template provided by the will creating module, which dynamically adjusts to local probate requirements and user-specific selections. The drafting process is guided by an AI-assisted interface, which prompts the user for key information such as asset inventories, beneficiary identities, executor appointments, and any special instructions or restrictions.

During the drafting stage, the application validates user inputs in real time, ensuring that required fields are completed and that legal compliance is maintained. Suggestions, warnings, and dynamic formatting may be provided to assist the user in finalizing a legally robust will. Once the drafting is complete, the user may review, edit, and approve the final document, which is then passed to the next stage of processing.

At step 320, the finalized will document is encrypted and securely stored within the computing system. The security module applies robust encryption algorithms, such as AES-256, to protect the will and any associated sensitive information. Modular encryption may be employed to allow different sections of the document, such as asset details or financial credentials, to be encrypted under separate keys for controlled access.

Once encrypted, the will is stored in secure servers managed by the database engine, with redundancy and disaster recovery protections in place. An audit entry is created to record the encryption event, and optional blockchain timestamping may occur at this stage to create an immutable proof of the document's existence and contents. The encrypted will remains securely stored and ready for future updating or transmission events.

At step 330, the application initiates ongoing monitoring of user activity via biometric scanning and behavioral analysis. The biometric scanning module captures user biometric data such as facial recognition or fingerprint scans at predefined intervals or during device interactions. Simultaneously, the activity monitoring module tracks behavioral patterns such as typing cadence, device movement, and application usage habits.

The combination of physiological and behavioral data provides a reliable indication of user presence and engagement with the computing system. Monitoring continues in the background without substantially interfering with the user's normal use of the application. If anomalies or inactivity are detected beyond pre-configured thresholds, subsequent steps are triggered to protect and appropriately manage the user's testamentary documents.

At step 340, the activity monitoring module detects that the user has been inactive for a period exceeding the predefined inactivity threshold. This threshold may be set by the user during onboarding or configuration, typically ranging between 12 and 60 months. Inactivity is determined based on a lack of biometric authentication events and absence of normal user behavioral indicators.

Upon confirming that the inactivity threshold has been surpassed, the will management module triggers the workflow for secure transmission of the stored, encrypted will. The system may generate notifications to designated recipients informing them of the pending release and may initiate secure channels for document delivery through the communication module. All activities associated with triggering transmission are logged for audit and compliance purposes.

At step 350, the application transmits the encrypted will and any associated documents to the designated beneficiaries, executors, or legal representatives as configured by the user. Transmission methods may include encrypted email, blockchain-based ledger transactions, or secure server-based download links that require multi-factor authentication to access.

Before transmission, the security module may validate the integrity of the will through cryptographic verification and, if applicable, blockchain timestamp comparison. Recipients receive authenticated copies of the will along with associated metadata such as timestamping proofs, version histories, and authentication trails. This final step ensures that the user's final wishes are reliably, securely, and legally delivered to the appropriate parties without requiring additional manual intervention.

In some alternative embodiments, the application program 200 may be deployed not only on individual mobile devices but also within enterprise environments, such as law firm management systems or estate planning services. In such configurations, the application may provide multi-user administration interfaces, allowing attorneys or estate managers to assist multiple clients in drafting, updating, and monitoring wills. These enterprise deployments may offer enhanced auditing capabilities, bulk document management tools, and advanced reporting features for administrative users.

In certain embodiments, the biometric scanning module 220 may be configured to capture additional biometric modalities beyond facial recognition and fingerprints. For example, the system may include voiceprint analysis, retinal scanning, or keystroke dynamics as part of the biometric profile. This multi-modal authentication approach may enhance the security and robustness of user identity verification, particularly in environments where users may have physical limitations affecting standard biometric capture.

In other embodiments, the system may integrate external identity verification services as part of the user onboarding process. Prior to granting access to the will creation functionality, the system may perform background verifications using government-issued ID scans, third-party identity databases, or facial liveness detection systems. This added layer of initial verification further protects against fraudulent account creation and ensures that testamentary documents are created only by authorized users.

In an alternative embodiment, the inactivity detection mechanism governed by the activity monitoring module 222 may be enhanced by incorporating geolocation tracking. For example, in addition to monitoring biometric activity, the system could detect substantial changes in user location patterns or prolonged absence from known geofenced areas. Such triggers could serve as alternative or supplemental indicators of user inactivity or incapacitation, prompting review or early transmission of stored documents.

In another embodiment, the transmission engine within the communication module 202 may support conditional or partial will transmission depending on the user's configuration settings. For example, the user may specify that only certain sections of the will, such as healthcare directives or emergency financial instructions, be transmitted after an initial period of inactivity, while the full will document is only transmitted after a longer threshold or confirmation by authorized witnesses.

Alternative embodiments may also utilize blockchain smart contracts to automate not only the timestamping but also the conditional release of the will. In such embodiments, the user's inactivity status, authenticated by the system, could trigger a smart contract deployed on a blockchain platform, which would automatically release encrypted will documents to specified recipients without requiring manual server-based transmission. This decentralized approach could increase system resilience and transparency.

In further embodiments, the platform may be integrated with insurance providers, financial institutions, or healthcare systems to dynamically update sections of the will based on external data feeds. For example, if the user opens a new financial account or modifies a life insurance policy, corresponding asset designations or beneficiary information could be suggested for updating within the will. Such integrations may require user consent and may operate through the secure API framework described herein.

In some embodiments, additional user preferences may be configured to allow for “emergency access” scenarios. The user may designate a trusted emergency contact who, upon proving incapacitation of the user through verified legal documents or notarized affidavits, can request expedited transmission of the will before the expiration of the inactivity period. This feature ensures flexibility in urgent cases while maintaining overall system integrity and preventing unauthorized access.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A computer-implemented method for end-of-life management, authentication, and transmission of a will and testament, the method comprising the steps of:
providing a mobile application with a jurisdiction-specific, legally compliant will testament;
collecting user input regarding one or more beneficiaries, one or more assets, one or more executors, and one or more guardians;
encrypting the completed will and associated sensitive data;
authenticating execution of the will using digital authentication by witnesses, executors, or legal participants through secure digital signatures and biometric verification;
monitoring user activity through biometric recognition; and
automatically transmitting the encrypted will to designated recipients upon detecting a predefined period of user inactivity.

2. The method of claim 1, wherein the mobile application utilizes artificial intelligence to assist the user in completing the will template based on provided user data.

3. The method of claim 1, wherein the biometric recognition comprises both facial recognition and fingerprint scanning.

4. The method of claim 1, wherein the period of user inactivity is adjustable between 12 and 60 months according to user preferences.

5. The method of claim 1, further comprising digital authentication of the will by witnesses, attorneys, or designated parties through encrypted electronic signatures.

6. The method of claim 1, wherein transmission of the will occurs via secure email, blockchain transaction, or secure server access link.

7. The method of claim 1, wherein the will document can be updated and re-encrypted by the user at any time prior to triggering the inactivity transmission.

8. A system for end of life management, authentication, and transmission of a will and testament, comprising:
a computing device in communication with a user interface configured to assist a user in drafting a will according to country-specific probate laws using an AI-engine;
a secure storage module for encrypting and storing the will, asset, information, and authentication data;
a biometric monitoring module to detect user activity using facial recognition and fingerprint scanning;
an authentication and digital signature module configured to enable witnesses, executors, and legal participants to authenticate involvement with the will using biometric verification or digital certificates to sign the will electronically; and
a transmission engine that, upon detecting a set period of inactivity, automatically dispatches the will to predefined beneficiaries, executors, or probate authorities.

9. The system of claim 8, wherein the secure storage module further encrypts, and stores associated legal documents, including powers of attorney, financial mandates, and cryptocurrency wallet credentials.

10. The system of claim 8, wherein the biometric monitoring engine continually validates user presence during scheduled intervals to reset the inactivity timer.

11. The system of claim 8, wherein the transmission engine sends notifications to designated parties prior to the full transmission of the will to confirm readiness.

12. The system of claim 8, further comprising a server architecture implementing role-based access control (RBAC) and multi-factor authentication (MFA) for accessing user data.

13. The system of claim 8, wherein the mobile device interface enables real-time updates to the will document and automatically revalidates compliance with applicable laws.

14. The system of claim 8, wherein the mobile application further comprises privacy control settings allowing users to define access levels for different recipients.

15. A non-transitory computer-readable medium having stored thereon instructions that, when executed by a processor, cause a computing device to perform the following:
present a dynamically formatted will template compliant with the user's local legal requirements;
guide the user in entering beneficiary, asset, and executor information;
authenticate the user through biometric verification mechanisms;
encrypt the user's will and associated data for secure storage;
perform digital authentication of the will by witnesses, executors, or legal participants using secure digital signatures and biometric verification; and
initiate an automatic transmission of the will to designated parties based on an inactivity time managed by biometric monitoring, wherein the non-transitory computer-readable medium provides end of life management, authentication, and transmission for the will and testament.

16. The non-transitory computer-readable medium of claim 15, wherein the instructions further cause the system to implement a reputation scoring system for witnesses or executors who participate in digital authentication.

17. The non-transitory computer-readable medium of claim 15, wherein the instructions cause encryption using an AES-256 standard for data at rest and TLS encryption for data in transit.

18. The non-transitory computer-readable medium of claim 15, wherein the biometric monitoring includes detecting anomalies in behavioral patterns to ensure identity authenticity.

19. The non-transitory computer-readable medium of claim 15, wherein the application performs regular vulnerability scanning and updates security protocols in real-time.

20. The non-transitory computer-readable medium of claim 15, wherein the will is transmitted alongside an audit log verifying document integrity and chain of custody.
